(19) United States
(12) Patent Application Publication
(10) Pub. No.: US 2014/0165854 A1
(43) Pub. Date: Jun. 19, 2014

(54) AGRICULTURAL PRODUCT CONTAINING AND CONDITIONING SYSTEM

(71) Applicants: Ole Green, Lem St (DK); Michael Peter Andersen, Soro (DK)

(72) Inventors: Ole Green, Lem St (DK); Michael Peter Andersen, Soro (DK)

(73) Assignees: KONGSKILDE INDUSTRIES A/S, Sorø (DK); WEBSTECH APS, Tjele (DK)

(21) Appl. No.: 14/237,815

(22) PCT Filed: Aug. 8, 2012
(86) PCT No.: PCT/DK2012/050288

§ 371 Date: Feb. 7, 2014

(30) Foreign Application Priority Data
Aug. 11, 2011 (DK) PA 2011 70441

(51) Int. Cl. B02B 5/00

(52) U.S. Cl. CPC B02B 5/00
USPC 99/468

(57) ABSTRACT

In order to provide a containing and conditioning system for an agricultural product, such as seeds or grains, which system reduces an amount of energy used upon containing and conditioning the agricultural product and also improves the quality of the agricultural product, there is disclosed a containing and conditioning system for an agricultural product, which may include seeds or grains. The system includes a container for containing the agricultural product, a conditioning device for conditioning the agricultural product, a stirring device for stirring the agricultural product, the stirring device including at least one wireless sensor for sensing characteristics of the agricultural product, which may include humidity and/or a temperature, and a control device operable for controlling said system in response to said characteristics.

### CROSS REFERENCE TO RELATED APPLICATIONS

This application is a U.S. National Phase Application of PCT International Application No. PCT/DK2012/050288, filed on Aug. 8, 2012, designating the United States of America and published in the English language, which is an International Application of and claims the benefit of priority to Danish Patent Application No. PA 2011 70441, filed on Aug. 11, 2011. The disclosures of the above-referenced applications are hereby expressly incorporated by reference in their entireties.

### FIELD OF THE INVENTION

The invention relates to a containing and conditioning system for an agricultural product, such as seeds or grains, and to a method for controlling a containing and conditioning system for the agricultural product. In particular the invention relates to a container or storage such as a silo for containing seeds or grain, in which silo the seeds or grain is conditioned prior to use thereof.

### BACKGROUND OF THE INVENTION

U.S.20030033057 discloses a grain aeration control system. The system can provide centralized monitoring of the aeration of a number of grain storage facilities, thereby improving management of stored grain. The grain aeration control system can allow the custodian of the system to offer an aeration service. Farmers, or other individuals, cooperatives, or companies can purchase the aeration service at a cost proportionate to the amount of stored grain to be aerated and the duration of storage.

A disadvantage of the system in U.S.20030033057 and other similar systems and methods may be seen to be that an amount of energy used upon containing and conditioning an amount of the agricultural product in a certain period may be quite costly.

Alternatively or additionally, a quality, i.e. a condition or state of the agricultural product being extracted from the containing and conditioning system can be further optimized.

In U.S. Pat. No. 4,293,854 a grain storage bin having a content stirring machine therein has a temperature sensor adjacent the stirring tool. The sensor is translated through the material in the bin by the stirring machine. A readout device outside the bin is coupled to the sensor wirelessly, or through slip ring contactors, there being appropriate circuitry associated with the sensor and readout device for the necessary information handling and processing. Possibilities for temperature and humidity determinations in the environment as well as in bin contents, and drier control, as needed, are disclosed.

Thus, the inventor of the present invention has appreciated that an improved containing and conditioning system for an agricultural product, such as seeds or grains, and an improved method for controlling a containing and conditioning system for the agricultural product is of benefit, and has in consequence devised the present invention.

### SUMMARY OF THE INVENTION

It may be seen as an object of the present invention to provide an improved containing and conditioning system for an agricultural product, such as seeds or grains, and to a method for controlling a containing and conditioning system for the agricultural product.

Preferably, the invention alleviates, mitigates or eliminates one or more of the above or other disadvantages singly or in any combination.

In particular, it may be seen as an object of the invention to provide a containing and conditioning system for an agricultural product, such as seeds or grains, and a method for controlling the containing and conditioning system, which reduces an amount of energy used upon containing and conditioning the agricultural product and preferably additionally improves the quality of the agricultural product.

Alternatively or additionally, it may be seen as an object to provide a system and a method which are simple but yet effective.

Accordingly, in an apparatus aspect of the invention, there is provided a containing and conditioning system for an agricultural product according to claim 1.

Thus, an improved containing and conditioning system for an agricultural product, such as seeds or grains, is provided.

An improvement or advantage of the disclosed system may be seen to lie therein that when the system is provided as set out herein a system which is simple but yet effective is provided.

Particularly, when the sensor is a wireless sensor and the sensor is comprised in the stirring device, a simple and yet effective system is provided. The system may alternatively or additionally enable energy to be saved compared to other storage and conditioning systems. The system may alternatively or additionally enable a quality of the agricultural product which has been extracted from the container to be improved.

When the sensor is attached to the stirring device at a position which is fixed relatively to at least a part of the stirring device and said sensor is moveable with said part of the stirring device, an embodiment of the invention is provided.

The sensor may be comprised in, such as attached, such as fixed to the described parts of the system from installation of the system. Alternatively, one or more sensors can be adapted to be refit able to a part of an existing and already installed system as an add-on.

Thus, upon refitting system and stirring devices with one or more sensors as described herein, and operating the system in the manner described herein with a control device as described herein, which control device operates the system in response to the characteristics sensed by the refitted sensors; great improvement of effectiveness of existing systems can also be provided.

In further embodiments of the invention the stirring device comprises a plurality of sensors, and additionally or alternatively a first of the plurality of sensors is comprised in the stirring device at another vertical height than a second of the sensors. This may be particularly preferred, e.g. in order to control a volume and/or a speed of air to be blown through the agricultural product in order to reach a certain condition of the product at or near a position of the sensor.

In a particular embodiment, the stirring device comprises a member extending in a horizontal or substantially horizontal direction. The stirring device further comprises at least one vertical or substantially vertically extending device, such as an auger. The vertical or substantially vertical device is preferably moveable along the horizontal member and thus moveable in a horizontal or substantially horizontal direction. The vertically or substantially vertically extending device comprises the sensor.

In accordance with a method aspect there is provided a method for controlling a containing and conditioning system according to claim 1.

The advantages or improvements described for the apparatus in accordance with the invention, similarly applies for the method.

In an embodiment of the method, moving the stirring device in a horizontal or substantially horizontal direction moves the sensor in a horizontal or substantially horizontal direction.

In a particular embodiment of the method controlling the system is provided in response to a plurality of measurements from a plurality of sensors provided at a plurality of different positions on the stirring device.

Specifically, controlling the system may comprise one or more of;
adding an amount of the agricultural product to the storage device, such as to a particular position of the storage, and/or
extracting an amount of the agricultural product from the storage device, such as from a particular position of the storage, and/or
controlling an amount of air being added to and/or extracted from the storage,
moving the stirring device, such as along a certain path and/or to a certain position, and/or
operating the stirring device in a certain mode, such as at a certain speed, and/or
operating the conditioning device, such as to dry or cool the agricultural product to certain extends and/or in a certain manner and/or in a certain position of the storage.

Specifically, the method as described can be carried out in order to optimize an amount of energy used upon containing and conditioning an amount of the agricultural product in a certain period and/or to optimize a quality of the agricultural product.

An example of such optimization is that upon controlled movement in the container of one or more stirring devices or parts of the stirring devices, where each stirring device or parts of the stirring device are provided with one or more sensors, e.g. a characteristic such as the temperature in different areas of the container can be determined.

In those areas of the container were the control device can determine that further conditioning, such as cooling, heating or drying, is needed, e.g. upon comparison of sensed characteristics with wanted characteristics, only in such areas of the container such further conditioning is provided. Thus, e.g., an energy efficient system and manner of providing the needed quality of the agricultural product is provided.

The further conditioning may e.g. comprise further air being provided in or towards a particular area. Alternatively or additionally the conditioning may comprise a certain way of stirring and/or further stirring in a particular area or position of the container. This may effect that conditioning in a certain area is changed.

In general, such and similar examples, provides an improved conditioning and thus quality of the agricultural product in the container.

The advantages and/or improvements described for the method aspect similarly applies for the apparatus aspect of the invention.

By referring to an advantage herein, it must be understood that this advantage may be seen as a possible advantage provided by the invention, but it may also be understood that the invention is particularly, but not exclusively, advantageous for obtaining the described advantage.

In general the various aspects and advantages of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates a system in accordance with an embodiment of the invention,

FIG. 2 illustrates a system in accordance with another embodiment of the invention,

FIG. 3 is a perspective view of a member mounted with augers,

FIG. 4 illustrates use of the system,

FIG. 5 illustrates an embodiment of the method in accordance with the invention.

### DESCRIPTION OF EMBODIMENTS

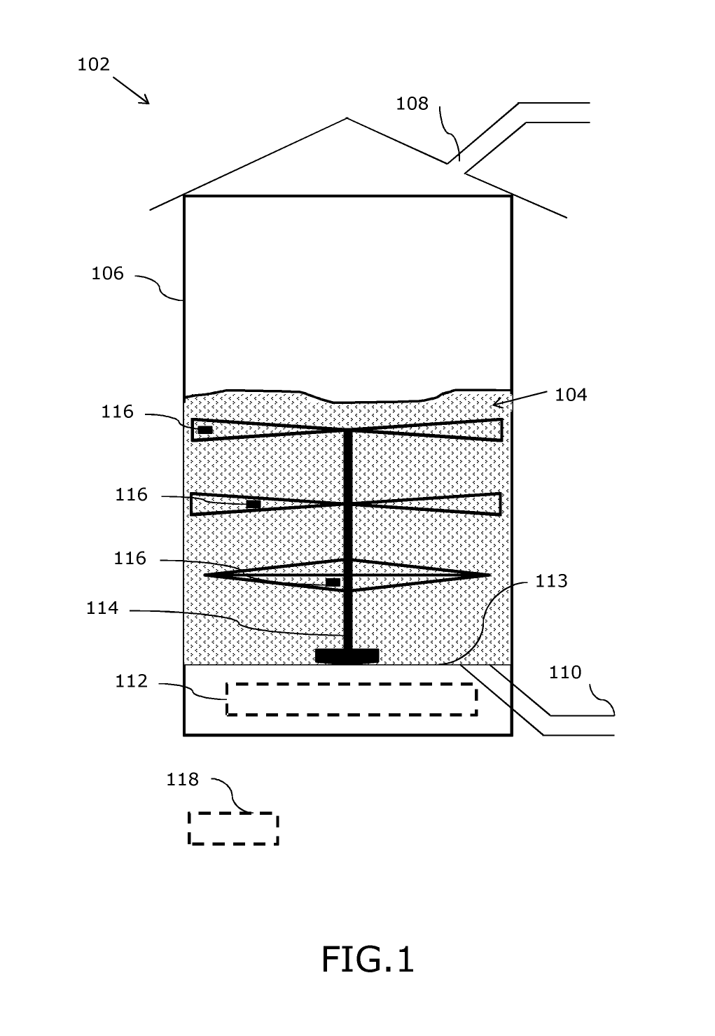

FIG. 1 is an illustration of a side view of a container 106 where most surfaces of the container are illustrated as invisible. The container may be a silo type, as illustrated, of e.g. 10 meters height and 4 meters width. Typically the containers are 6-16 meters in diameter and about 8-10 meters of height. Alternatively the container is only 2 meters high but 20 meter in diameter. Alternatively the container is a plan storage, e.g. for a malting plant.

The container is suitable for containing and conditioning a substantial volume, such as from 10 cubic meters and more of an agricultural product such as grain or seeds. As examples the agricultural product may be wheat, barley, soya beans, sunflower seeds, maize, corn or the like.

In particular the figure illustrates a containing and conditioning system 102 for an agricultural product 104, such as seeds or grains. The system includes the container 106 for containing the agricultural product. It can be seen that the container has an inlet 108 and an outlet 110 for the agricultural product and that the system includes a conditioning device 112 for conditioning the agricultural product inside the container.

The conditioning device may comprise a fan like structure and/or a means for extracting humidity from air and/or a cooling device and/or a heating device for conditioning the agricultural product 104 such as to adjust a temperature and/or moist level or relative humidity or humidity of the product.

The agricultural product is illustrated as placed within the container and above a perforated plate 113 so as to provide some separation between the conditioning device 112 and the agricultural product 104. The container is illustrated as filled to slightly more than half of its capacity.

The figure also illustrates that the system includes a stirring device 114 for stirring the agricultural product. In FIG. 1 the stirring device 114 is a rotatable fan like device for moving and mixing the agricultural product and in particular for transferring the agricultural product from an area close to the conditioning device 112 and away from the conditioning device in order for all of the agricultural matter to be subjected to the same conditioning.

A uniform conditioning and/or extraction of equally conditioned seeds or grains, is particularly possibly when the system is as disclosed herein and when the system is operated as disclosed herein.

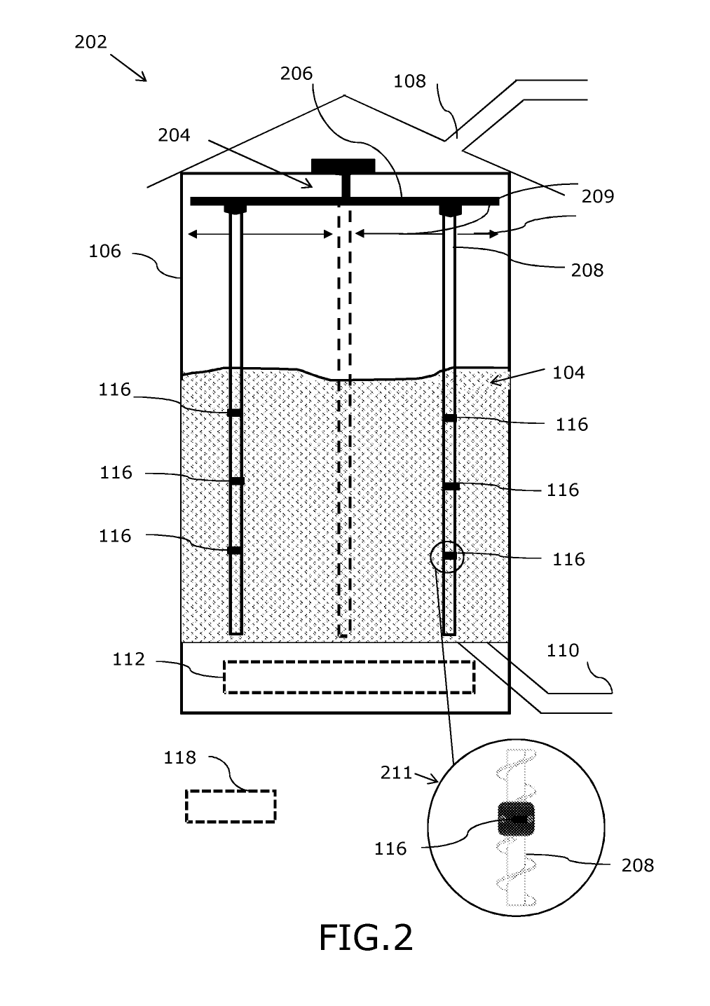

In FIG. 2 the stirring device is illustrated as a rotatable horizontal cross member with one or more horizontally extending augers, which augurs can rotate around their own axis of rotation and move along the horizontally member. The purpose of this embodiment of the stirring device is the same as for the stirring device illustrated in FIG. 1.

Instead of three big fan-like blades as illustrated, the stirring device 114 may comprise any other form such as comprising a plurality of smaller and possibly individually operated blades, moveable perforated tubes blowing conditioned air into the agricultural product etc.

It is disclosed and illustrated that at least one sensor 116 for sensing characteristics, such as humidity and/or a temperature, of the agricultural product 104 is comprised in the stirring device. It is illustrated that a sensor is attached to each of the left side blade parts of the stirring device 114. Thus a plurality of sensors 116 is comprised in the stirring device. A first and a second of the sensors are attached and positioned at different positions and fixed relatively to the blade of the stirring device. In that the position of the stirring device is known the vertical position of the sensors is also known.

Alternatively or additionally, the system and the one or more sensors may be equipped with a positioning system enabling determination of the position(s) of the one or more sensors in the container.

Furthermore it follows that the sensors 116 are positioned at different positions in a horizontal plane, i.e. at different positions in a radial direction of the container. A control device 118 is illustrated and operable for controlling the system in response to sensed characteristics. The sensor 116 is a wireless sensor adapted for wirelessly transmitting sensed characteristics constantly or e.g. each minute, each second minute, each half hour, every hour or in another time schedule. The sensor is preferably provided with a means as its own source of energy, such as a battery which can operate the sensor for a month or longer.

In that the moveable parts of the stirring device, when in operation and when agricultural product is inside the container, are in contact with the agricultural product the sensor will also constantly be in contact with the agricultural product and thus precise measurements of e.g. the humidity and temperature of the agricultural product are obtained by the sensor. In that the stirring device moves or can be moved by rotation or in any other way, changed agricultural product matter may constantly be measured by the sensor 116. Moreover, it also understood from the present description that constantly changed agricultural product can be measured by positioning the sensor on the stirring parts, such as one or more augers, of the stirring device. Thus, the system and method makes it possible to monitor the entire stock stored in the container, such as a steel silo with stirring grain augers.

In FIG. 2 a system somewhat similar to that illustrated in FIG. 1 is illustrated. As briefly mentioned under FIG. 1, the stirring device in FIG. 2 is different from that illustrated in FIG. 1.

It is shown that the stirring device 204 comprises a member 206 extending in a horizontal or substantially horizontal direction and at least one vertical or substantially vertically extending device 208, such as a rotatable auger 208.

The vertical or substantially vertical device is preferably of a moveable type, which can be moved to travel along the member 206. As shown the two vertically or substantially vertically extending devices or augers 208 each comprises three sensors 116.

Moving the member 206, such as by rotating it one complete turn during a period of each 24 hours, and moving the rotation augers along the member 206 as illustrated with the horizontal arrows 209, will enable the moveable parts, in this example the augers 208 with one or more sensors 116 of the stirring device, to reach every position or area within the container. Using a distributed wireless sensor system makes it possible to identify smaller patches of wet seeds or grain and carry out differentiated drying, improving quality and saving energy.

The augers are provided with a profile for pushing the seed or grain away from the bottom of the container 106 by rotating the auger around its own axis of rotation. A close up of an auger profile with an attached sensor is illustrated at 211. In this example the sensor 116 is shown attached to a surface of the auger 208.

The position and way of attaching or incorporating the sensor in the stirring parts, such as the auger, i.e. agricultural product moving parts of the stirring devices 114,204, may e.g. be selected in dependence of which product is to be contained, conditioned and sensed and/or in view of the particular auger or agricultural product moving part to which part the sensor is to be attached to or incorporated in.

The size of the sensor and way of attaching or incorporating it may e.g. alternatively or additionally be provided so as to decrease any influence by the sensor of the product flow, which product flow is to be provided by the stirring device 114, 204.

A way of incorporating the sensor in the stirring parts, such as in one or more augers, may be to provide a hole or indentation or similar in the stirring part and incorporate the sensor in this hole or indentation.

The illustrated stirring device comprises an auger 208 with a diameter of e.g. 0.20-0.70 meter. When the auger has a diameter of e.g. 0.3 meters, the sensor may be provided as a box which is a few millimetres, such as 5-7 mm, thick and some centimetres, such as 3-5 cm, wide and long. The box may be attached to the auger such as by a bracket which bracket fastens the box and the bracket to the auger.

The box may or may not have openings in order to sense the characteristics. It may be preferred that the box does not have openings of a size which enables the agricultural product or dust therefrom to enter the openings, which may be preferred in order for such openings not possibly to be filled by the agricultural product, which may not be preferred.

In such case the box may be provided with one or more surfaces closed by a material through which material the surrounding temperature, or a measure correlated thereto, i.e. of surrounding agricultural product outside the box can be sensed.

Alternatively or additionally the surface is of a kind which may constantly be in contact with and cleaned by the agricultural product sliding over its outer surface.

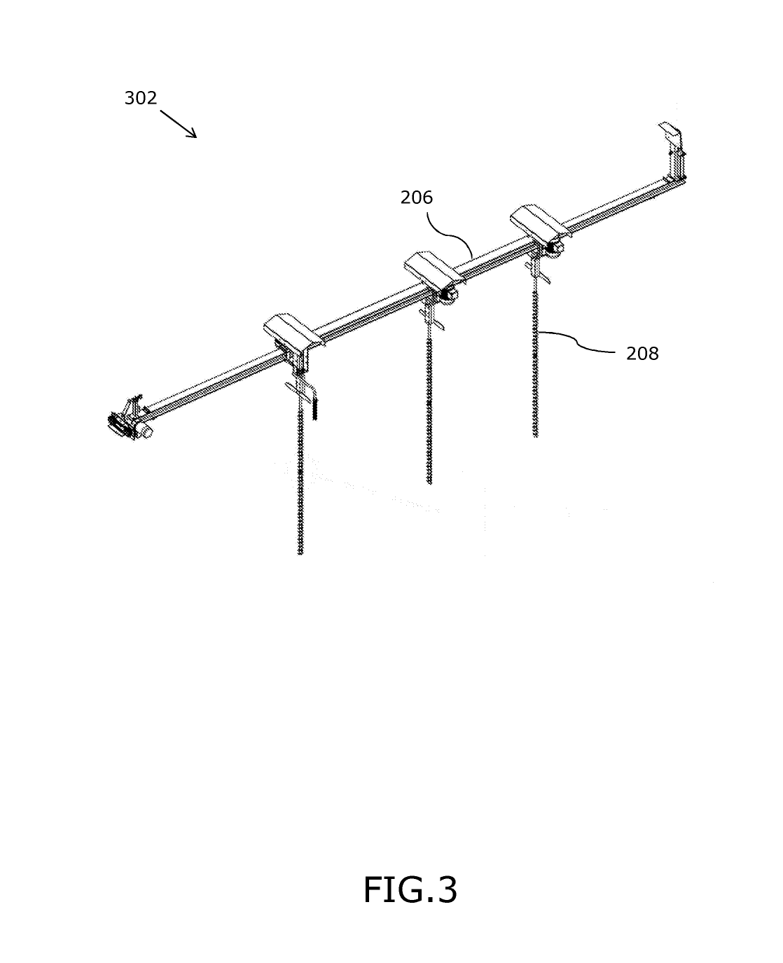

Alternatively or additionally the material is adapted to allow a level of humidity of the outer surface to be sensed on an opposite inner surface of the material inside the box. Such material may be a thin layer, such as below 1 millimetre, of material through which humidity or moist particles, or a measure correlated thereto, are able to diffuse through and/or be measured through, rather quickly, but which material leaves the agricultural product on the outer surface. FIG. 3 is a perspective top view 302 of the member 206 as illustrated in FIG. 2, but in this example shown with three augers 208.

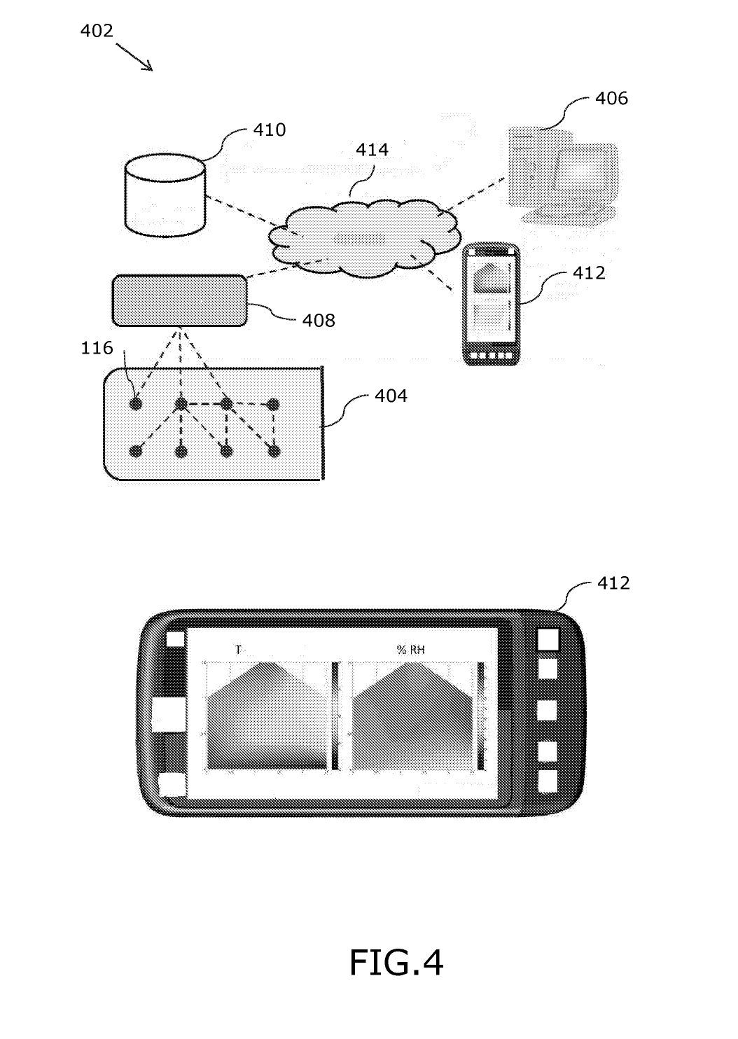

The arrow 402 in FIG. 4 illustrates using the system and method for wireless monitoring of agricultural products, such as seed or grains. The dashed lines between the various boxes illustrate one or two way communication, such as transferring data and/or requests. A container with sensors is illustrated at 404. In the example, the sensors communicate with a base station 408. The sensors may or may not communicate with each other, such as to use each other as repeaters as indicated with the dashed lines between individual sensors 116.

Data processing and/or storage of data are/is illustrated at 410 and/or 406 and/or at the base station 408. The reference 414 illustrates the internet, through which data, requests, results and/or alarms and/or current status or conditions in a container may be uploaded to or transferred via.

If an operation mode of the system is not changed automatically by the control device 118 in response to sensed characteristics, alternatively or additionally, the computer 406 or the smart phone 412 may be used to operate or change operation of the conditioning system manually via the computer and/or via the smartphone 412.

Alternatively or additionally to the computer 406, the smart phone can be used, e.g. by a farmer, for receiving results and/or a status of the conditions such as temperature (T) and relative humidity (% RH) throughout the agricultural product in the container. On the display of phone 412 there is shown a distribution of temperature and relative humidity in the container.

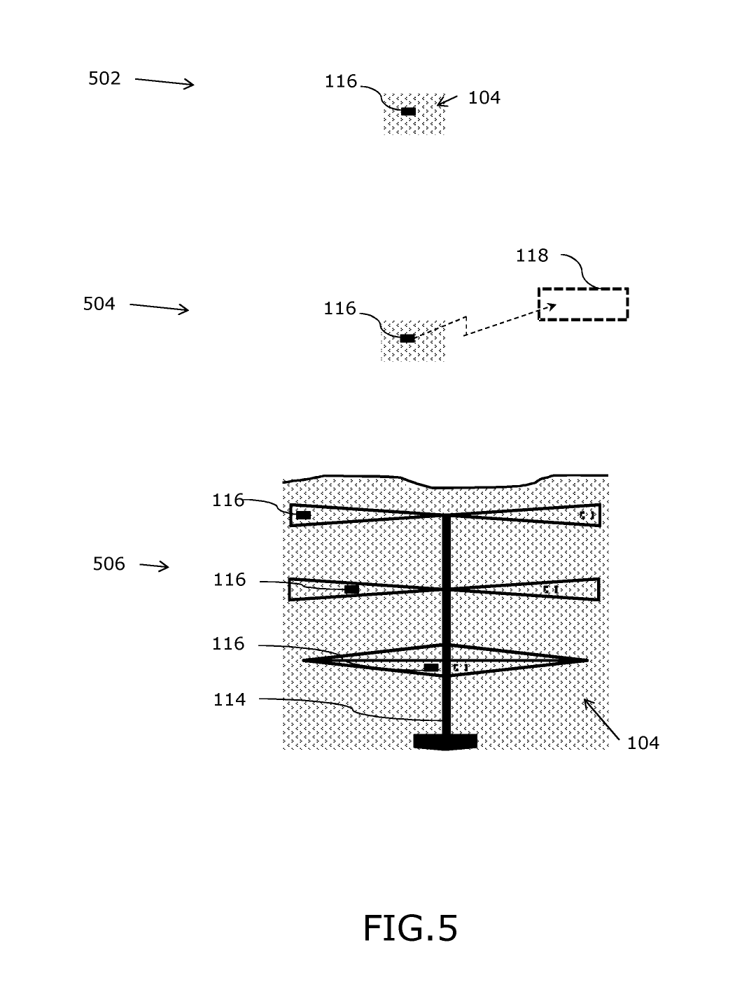

FIG. 5 illustrates the method for controlling a containing and conditioning system for an agricultural product 104, such as seeds or grains. In particular the figure illustrates sensing characteristics, pointed towards at reference 502, such as humidity and/or a temperature of said agricultural product within said container with a sensor 116.

Further the figure illustrates transmitting 504 the characteristics wirelessly from the sensor 116 to the control device 118. Operating said stirring device, such as rotating the three illustrated blade, is illustrated at 506 at which it is illustrated that upon a 180 degrees rotation of the stirring device the sensors 116 are moved horizontally within the storage.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims however the inclusion of the reference signs is only for clarity reasons and should not be construed as limiting the scope of the claims.

1. A containing and conditioning system (102, 202) for an agricultural product (104), such as seeds or grains, said system comprising
a container (106) for containing the agricultural product, the container having an inlet (108) and an outlet (110) for the agricultural product,
a conditioning device (112) for conditioning the agricultural product,
a stirring device (114, 204) for stirring the agricultural product,
at least one sensor (116) for sensing characteristics of the agricultural product (104), such as a humidity and/or a temperature,
a control device (118) adapted to control said system in response to said characteristics and wherein said sensor (116) is a wireless sensor and said sensor is comprised in said stirring device (114, 204).

2. The system according to claim 1, wherein said sensor (116) is attached to said stirring device (114, 204) at a position which is fixed relatively to at least a part of the stirring device and said sensor is moveable with said part of the stirring device.

3. The system according to claim 2, wherein said part is a stirring part of said stirring device and said sensor (116) is attached to or incorporated in said stirring part.

4. The system according to claim 3, wherein said part is an auger (208) and said sensor (116) is attached to or incorporated in said auger (208).

5. The system according to any of the preceding claims, wherein the stirring device (114, 204) comprises a plurality of said sensors (116).

6. The system according to claim 5, wherein a first of said plurality of sensors (116) is comprised in the stirring device (114, 204) at another vertical height than a second of said plurality of sensors.

7. The system according to any of the preceding claims, wherein said stirring device (204) comprises a member (206) extending in a horizontal or substantially horizontal direction and at least one vertical or substantially vertically extending device (208), such as an auger (208), the vertical or substantially vertical device preferably being moveable along said member (206) in said horizontal or substantially horizontal direction and wherein said vertically or substantially vertically extending device (208) comprises said sensor (116).

8. The system according to claim 7, wherein said vertically or substantially vertically extending device (208) is an auger (208).

9. A method for controlling a containing and conditioning system for an agricultural product (104), such as seeds or grains, said system (102, 202) comprising a container, a stirring device, a conditioning device and a control device, said method comprising
sensing (502) characteristics such as a humidity and/or a temperature of said agricultural product within said container with a sensor (116),
controlling said system in response to said characteristics with the control device, wherein the method further comprises
transmitting (504) said characteristics wirelessly from said sensor (116) to said control device, and
operating (506) said stirring device and hereby moving said sensor within said storage.

10. The method according to claim 9, wherein said stirring device comprises an auger (208) and wherein said sensor (116) is attached to or incorporated in said auger (208).

11. The method according to claim 10, wherein operating (506) said stirring device comprises rotating said auger (208) and hereby enabling changed agricultural product matter constantly to be measured by the sensor (116).

12. The method according to claim 9, wherein moving said stirring device in a horizontal or substantially horizontal direction moves said sensor in a horizontal or substantially horizontal direction.

13. The method according to any of the preceding claim 9 or 12, wherein controlling said system is provided in response to a plurality of measurements from a plurality of sensors provided at a plurality of different positions on said stirring device.

14. The method according to claim 13, wherein a first of said plurality of sensors (116) is comprised in the stirring device (114, 204) at another vertical height than a second of said plurality of sensors.

15. The method according to any of the preceding claim 9, 12 or 13, wherein controlling said system comprises at least one of;
adding an amount of the agricultural product to the storage device, such as to a particular position of the storage,
extracting an amount of the agricultural product from the storage device, such as from a particular position of the storage,
controlling an amount of air being added to and/or extracted from the storage,
moving the stirring device, such as along a certain path and/or to a certain position,
operating the stirring device in a certain mode, such as at a certain speed,
operating the conditioning device, such as to dry or cool the agricultural product to certain extends and/or in a certain manner and/or in a certain position of the storage.

16. The method according to any of the preceding claim 9, 12, 13 or 15, wherein controlling said system is carried out in order to optimize an amount of energy used upon containing and conditioning an amount of the agricultural product in a certain period and/or to optimize a quality of the agricultural product.
